(19) United States
(12) Patent Application Publication
(10) Pub. No.: US 2006/0076286 A1
(43) Pub. Date: Apr. 13, 2006

(54) Water round dispenser

(76) Inventor: Aaron Dean Bolin, Huntington Beach, CA (US)

Correspondence Address: AARON BOLIN, 7982 BAYPOINT DR. #101, HUNTINGTON BEACH, CA, 92648, US

(21) Appl. No.: 10/950,021

(22) Filed: Sep. 24, 2004

(51) Int. Cl. B01D 27/02

(52) U.S. Cl. 210/282

(57) ABSTRACT

My water round dispenser is designed for the public use. It's new features are: an access panel which enables the consumer to interchange the filter quad when as needed. The filter quad is three filters in one. It consists of 1½ inch of sand carbon, 1½ inch of carbon, and ½ inch of cotton fibers. This will enhance the purity of water. There is a ½ gallon holding tank above the filter to pour own muncipal water into . Theres. a ⅛ inch slip plate, it slides in and out to hold the water above holding tank. The filter quad has a built in lock system on each side of the filter. A push button incerts the lock system secures to the back wall into a female block. On top of the filter is a ¼ inch groove on each side of filter, this allows it to keep on track. When installing the filter slides on a 1 inch lip on each side of filter. No tools needed to install.

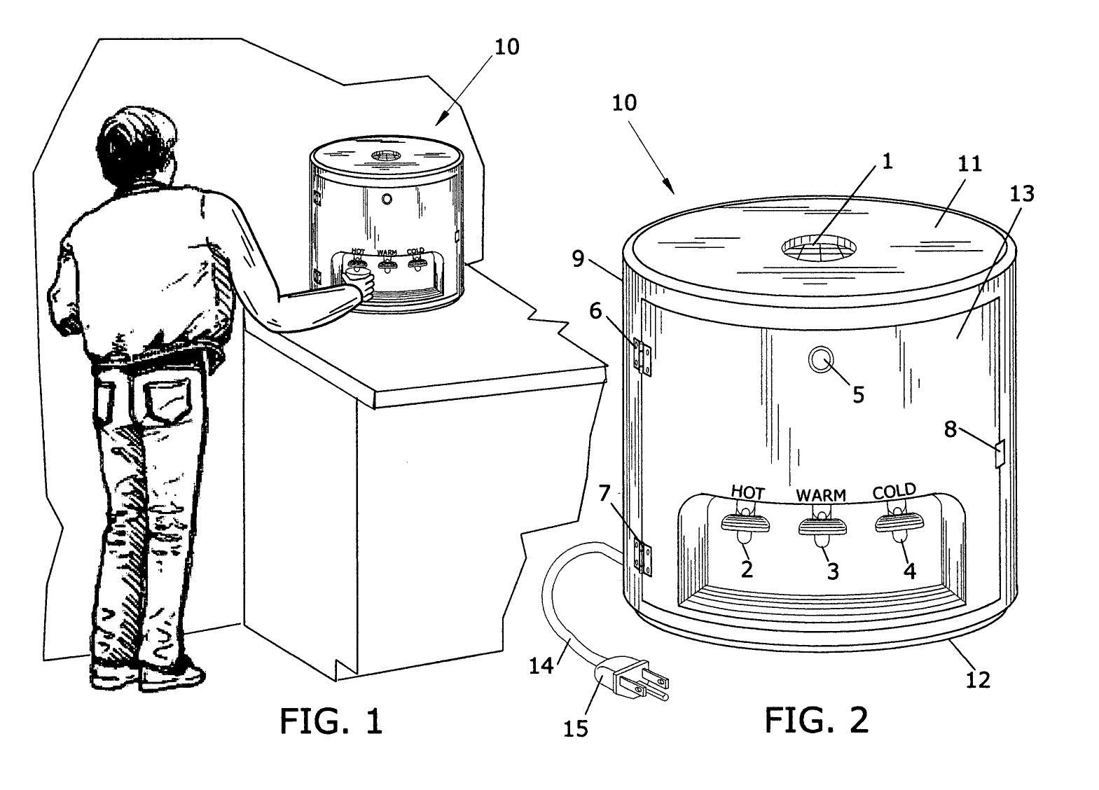

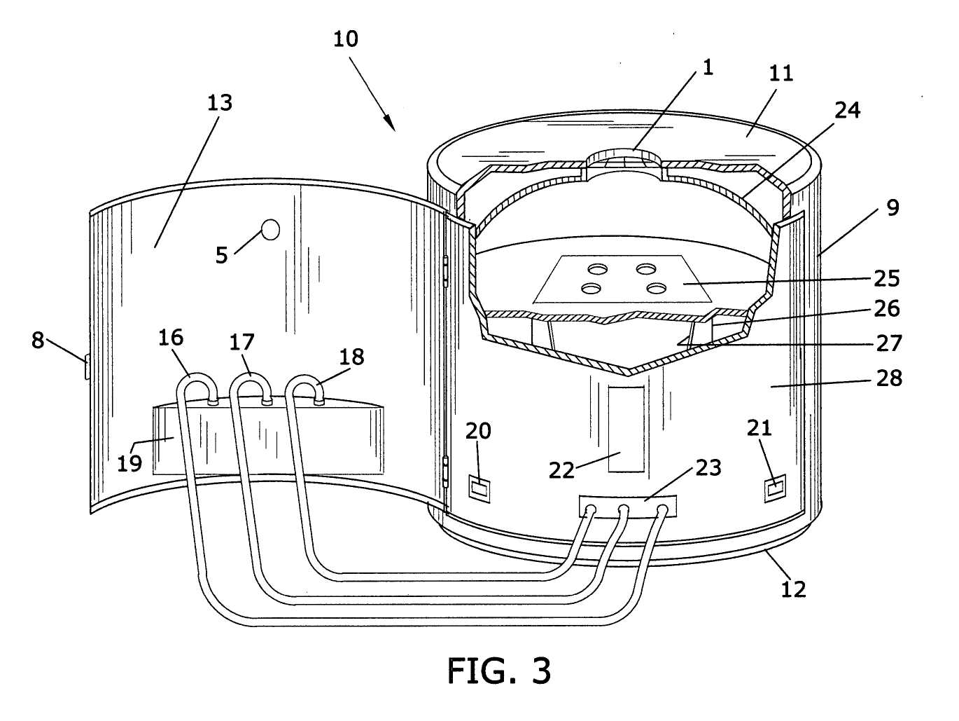

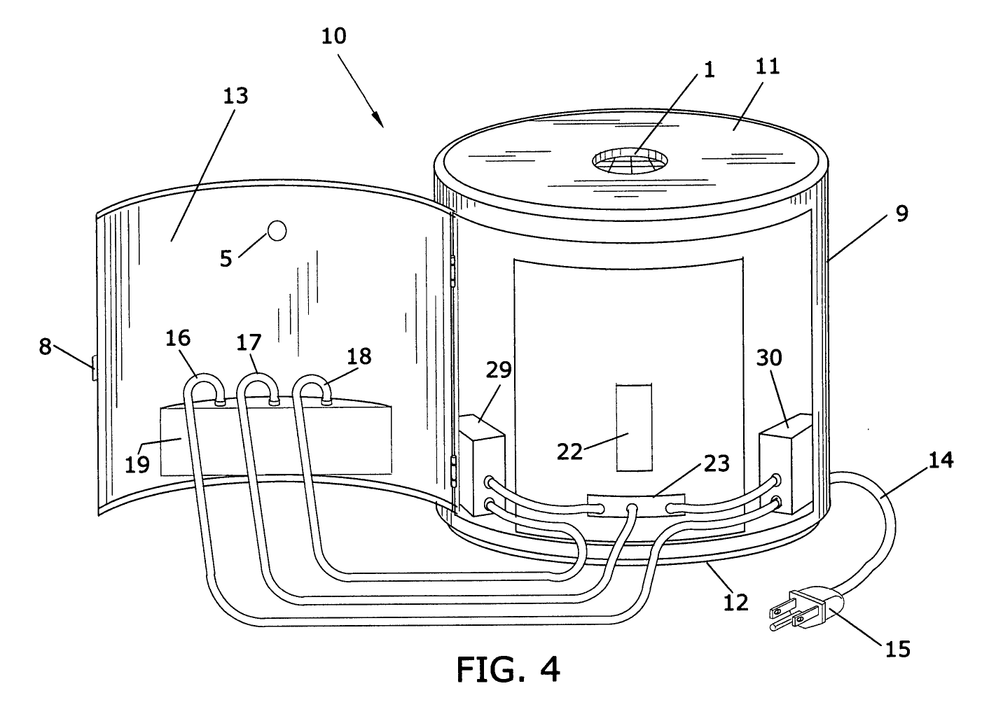

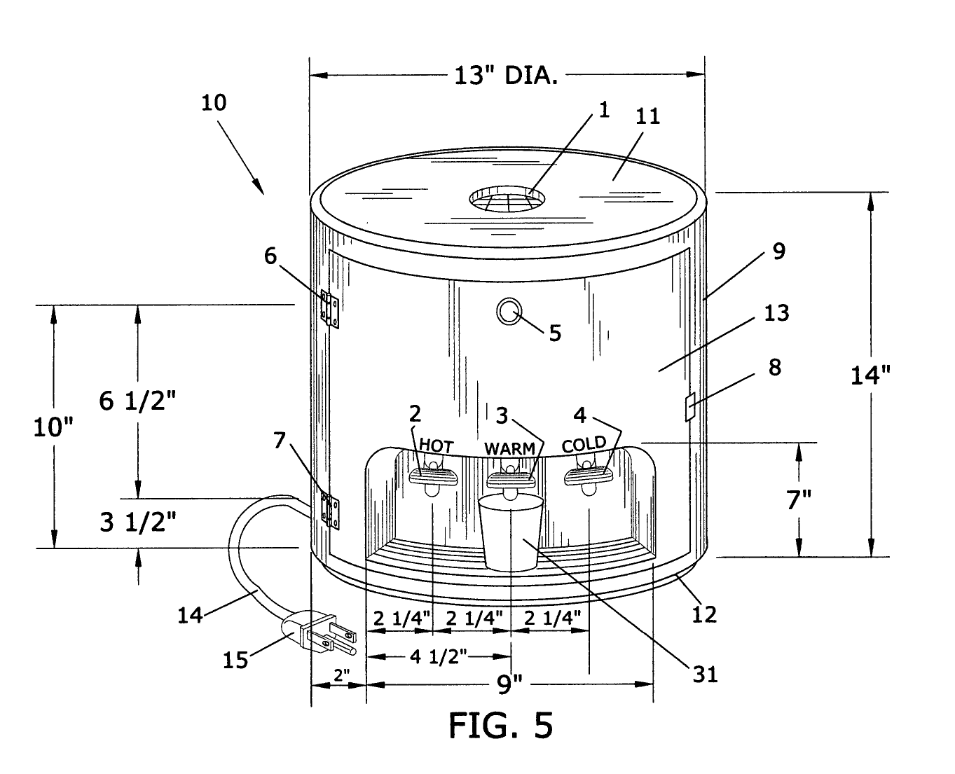

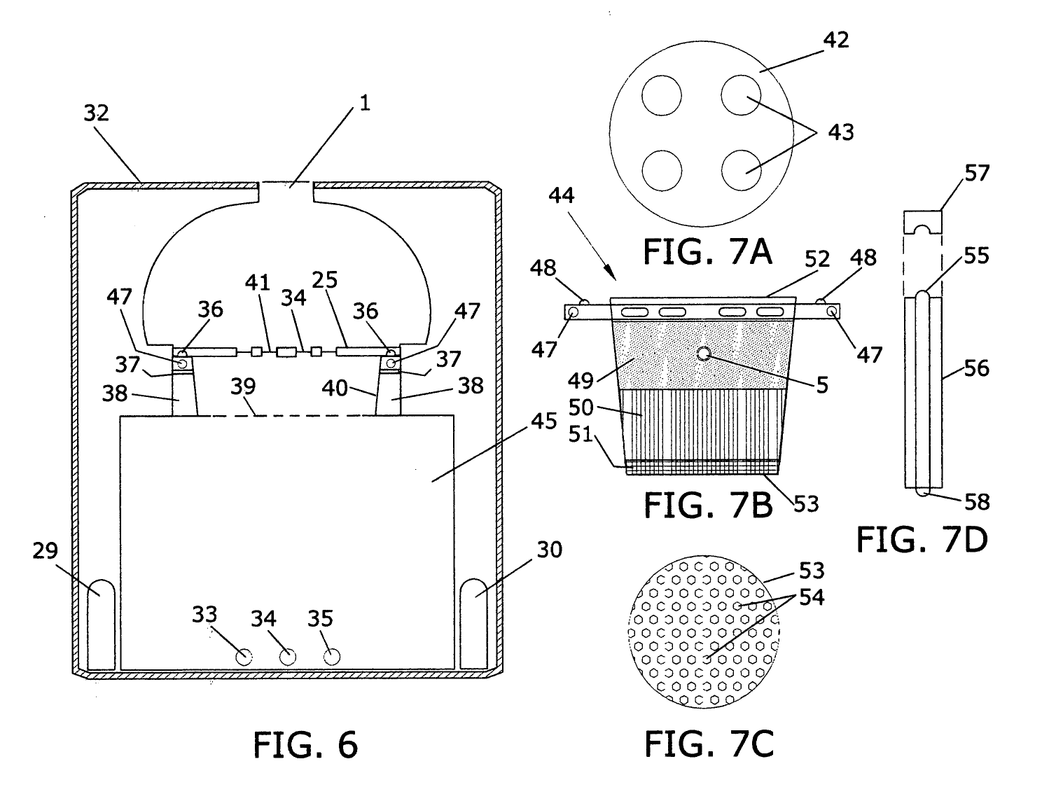

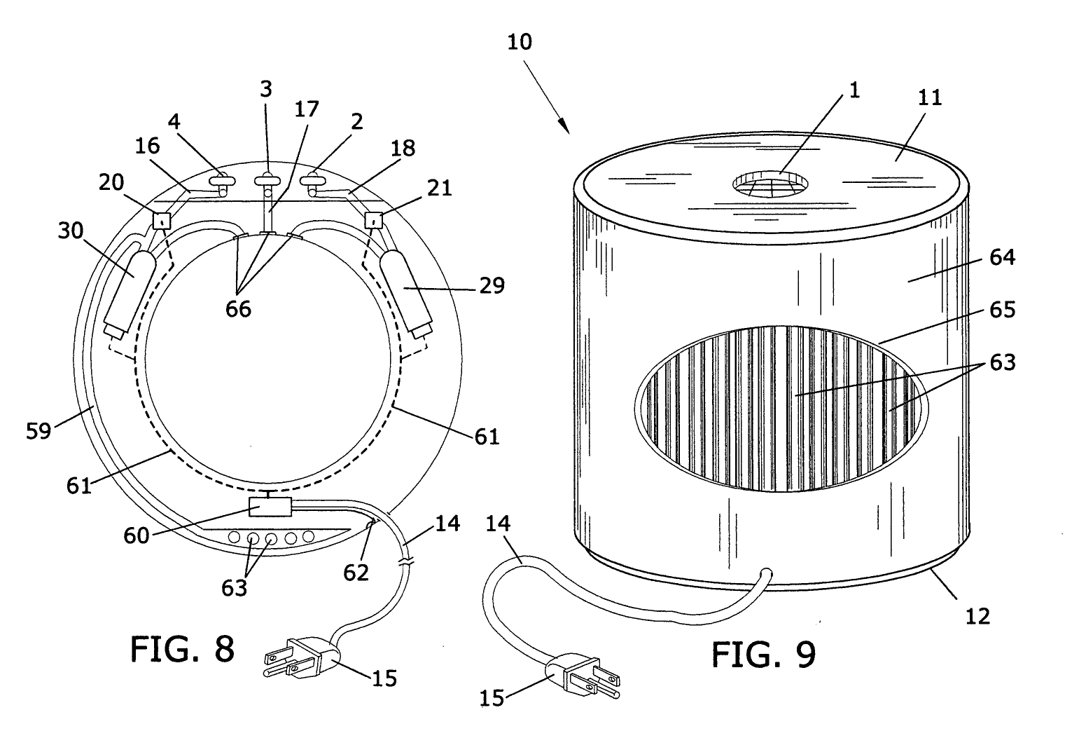

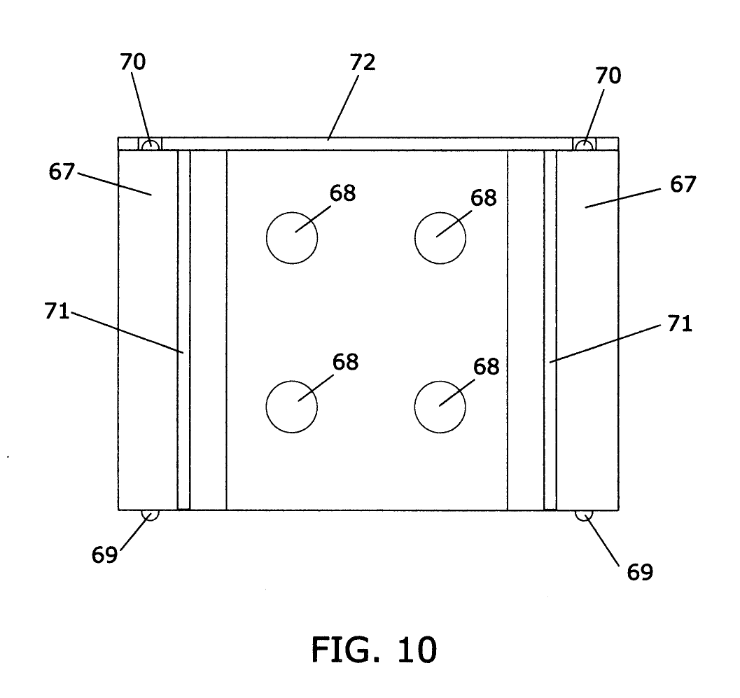

### BACKGROUND OF THE INVENTION

In todays society the majority of people, everyday people, buy bottle water or buy a filtration system device. For many years people try to find the best quality , best value, and convience the average price for bottle water a 5-gallon is $8.00. the average price for 20 oz sport bottle is $1.50 per bottle. I thought long and hard, how I could I provide a top quality water filtration system. This water system would be used in kitchen , RV trailer, office, anywhere electric is supplied. My water round dispenser is affordable, compact, produces the best quality water so the consumer can enjoy everyday. The consumer will be impressed with the design and the process of the filtration.

### BRIEF SUMMARY OF THE INVENTION

the water round dispenser is the answer to the world's dirty water Solution. The filter quad is designed to eliminate lead, chlorine, lindane, (a pesticide ) atrazine (a herbicide, mercury, asbestos. The filter quad has a built in lock device, this prevents the filter quad from leaking or moving out of place. Anyone can slide the filter quad into the filter port. The filter quad is 3½ inches height x 5½ inches top length x 3½ inches depth x 2½ inches bottom plate . The filter quad consists of 1½ inches thick of sand carbon. The 2^{nd} layer is 1½ inches of carbon. The 3 rd layer is ½ inch cotton fiber. This water then enters a 1 gallon holding tank. The clean crystal drinking water is ready to be dispense. I also designed a filter light on the filter quad, to regulate filter life. This water process will be far superior than any other filter device in the market. The water round dispenser has a open panel, this allows you to have access to the filter quad, a hot water switch, a cold water thermostat. It's total size is 14 inches in height and 13 inches in diameter. This will fit on any kitchen counter space. The top ½ gallon holding tank is designed to slowly drain through the filter quad. The 1 gallon holding tank, holds the crystal clear water ready to be dispense out, to hot water, or cold water pump, or simply room temperature water. The hot water will be so hot you can make instant hot chocolate, instant coffee, or hot soups. The cold water will be so cold for those hot summer days, when you need to cool down. Millions of people can now enjoy great tasting water from their own water round dispenser.

### CONTENT OF THE DISCLOSURE DOCUMENT

My water round dispenser is engineered for the public use. My water filtration system is easy to use. The water round dispenser, proficiency process filters muncipal water into sparkling clean purified drinking water. The consumer pours ½ gallon of muncipal water into the water round dispenser . There is a three inch diameter hole on top for water inlet the water is collected into a ½ gallon holding tank before entering the filter quad The water is held in by a ⅛ inch thick slip plate. The filter quad is designed with three filters in one. The filter quad is engineered with three filter stages. First layer of filter is sand carbon. The second layer of filter is carbon filter. The third layer is cotton fiber filter. The filter quad lock in system consists of ¼ inch groove on each side of the filter quad to keep it on track. The push in lock button incerts the pins into the back wall. The back wall has a female block that it locks on to. The consumer can lock or unlock by pushing the two buttons on each side of the filter quad. The water round dispenser is created with a open access panel to exchange the filter quad as needed. Once the water is filtered through the filter quad, the one gallon holding tank; it retains the clean purified water before dispensing. There are three different water temperatures you can select from. You can have hot, cold, or warm. There will be millions of people that will use my water round dispenser instead of buying bottle water at a high price. The consumer will save hundreds of dollars every year, when using the water round dispenser. This unique invention will be a great benefit for the future water drinkers.

1. What I claim as my invention is the water round dispenser has a hinged access to inside panel for easy visible water filter to change as needed. The latch is on the right side of the door. The hinge is on the left side.

2. What I claim as my invention is, the inside panel on FIG. #2 is securely mounted to protect the consumer from electrical parts, componets, and pumps.

3. What I claim as my invention is the water round dispenser is engineered with a ½ gallon holding tank in FIG. #2. The holding tank is above the filter quad. This allows the consumer to pour ½ gallon of water at one time for purified water.

4. What I claim as my invention that the water round dispenser, is a compact water filtration system. It will fit on any kitchen counter. It's size is 14″ in height and 13″ diameter.

5. What I claim as my invention is the water round dispenser is engineered with a ⅛″ thick slip plate to control the water flow into the filter quad. This slip plate is for the consumer to keep a reserve ½ gallon holding tank full. The same time you can change the filter quad as needed.

6. What I claim as my invention is the water round dispenser is engineered for the consumer to pour their own water source into the ½ gallon holding tank. There are four ¼ diameter holes for slow water flow into the filter quad.

7. What I claim as my invention is the filter quad is engineered to slide on a 1 inch lip on both sides of the filter quad. This allows the consumer for easy install. This slides easy on the lock track.

8. What I claim as my invention is, the filter quad has it's lock in system for best filter performance. The ¼ inch groove on top of the filter quad. This is the length from front to back. This allows on the lock track the push lock button is on each side of the filter quad. The lock pin is located on the back side of filter. This secures the filter quad from moving.

9. What I claim as my invention is, uniquely engineered three filters in one. The first stage of the filter consist of 1½ inch thick of sand carbon. The third stage of the filter quad consists of ½ inch of carbon. The third stage of the filter quad consists of ½ inch of cotton fiber. This combination of material will be and the best filter process of it's kind.
